(19) United States
(12) Patent Application Publication
(10) Pub. No.: US 2025/0254490 A1
(43) Pub. Date: Aug. 7, 2025

(54) SYSTEMS AND METHODS FOR USER ALLOCATION FROM MOBILE COMMUNICATION EVENTS

(71) Applicant: VERIZON PATENT AND LICENSING INC., Basking Ridge, NJ (US)

(72) Inventors: Howard MIZES, Salem, SC (US); Daniel Jacob ABREU, San Jose, CA (US); Kaiss K. ALAHMADY, Plano, TX (US)

(73) Assignee: VERIZON PATENT AND LICENSING INC., Basking Ridge, NJ (US)

(21) Appl. No.: 18/432,132

(22) Filed: Feb. 5, 2024

(51) Int. Cl. H04W 4/021; H04W 4/029; H04W 64/00

(52) U.S. Cl. CPC H04W 4/021; H04W 4/029; H04W 64/006

(57) ABSTRACT

Disclosed are systems and methods for a computerized, network-based framework that provides enhanced algorithmic mechanisms for improving GSM location determinations for cell tower communications. The disclosed framework's operations can provide improved visit determinations/estimates and increased value for a user's wireless/cellular data, whereby optimized parameters from and/or of the signals associated with a user device (e.g., mobile device) and tower radio communications therebetween can be leveraged to discern the POIs a user has visited and/or is currently visiting. The location tracking of the user, within a predisposed uncertainty sector correlated among the user's device communications with corresponding radio towers, provides network coverage to track specific locations among POIs for which the user has visited and/or is currently located.

### BACKGROUND INFORMATION

Many cellular network processes and systems, as well as many applications, rely on determining the geographic location of user equipment (UE). Many systems utilize determinations of UE locations via Global System for Mobile Communication (GSM) localization; however, such approaches can yield location estimates with significant margins of error, thereby reducing the use of this data by systems that require high-fidelity location data, and applications which may consume such data.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example network architecture according to some embodiments of the present disclosure;

FIG. 2 is a block diagram illustrating components of an exemplary system according to some embodiments of the present disclosure;

FIGS. 3A-3C depict non-limiting example embodiments for performing the operations of the disclosed systems and methods according to some embodiments of the present disclosure;

FIG. 4 illustrates an exemplary workflow according to some embodiments of the present disclosure;

FIGS. 5A-5C illustrate exemplary implementations according to some embodiments of the present disclosure;

FIG. 6 illustrates a non-limiting example embodiment of a network architecture according to some embodiments of the present disclosure; and

FIG. 7 is a block diagram illustrating a computing device showing an example of a client or server device used in various embodiments of the present disclosure.

### DETAILED DESCRIPTION OF EXAMPLE EMBODIMENTS

According to some embodiments, the disclosed systems and methods provide a novel computerized, network-based framework that provides enhanced algorithmic mechanisms for improving GSM location determinations for cell tower communications. In some embodiments, such determinations can correspond to situations when a user is determined to not be moving (or, in some embodiments, moving at a rate or within a proximity that falls within a movement threshold (e.g., staying within a 100 meter radius of an initial position, for example). As discussed herein, the disclosed framework's operations can provide improved visit determinations/estimates and increased value for a user's wireless/cellular data (e.g., telecom operator data for a user and/or the user's device, for example). As provided herein, the disclosed framework can optimize parameters associated with the communication signals associated with and/or between a user device (e.g., mobile device) and tower radio communications.

According to some embodiments, as discussed in more detail below, historic communication events associated with stationary users can be utilized to extract a comprehensive estimate of the uncertainty in the distance estimate for all cell towers. Based on such information, an uncertainty sector can be defined for each communication event for each stationary user. As discussed below in more detail, uncertainty (e.g., an uncertainty sector) in UE location estimates can be asymmetric, irregularly shaped and/or dependent on the user position. For example, for unidirectional outside cell towers, an estimate of a distance from the tower to the UE can be more accurate than the estimate of the angle between the tower and the UE.

Accordingly, for each communication event, points of interest (POIs) contained within the uncertainty sector can be scored as a potential visit to such POI. In some embodiments, POI scores for each or a portion of the POIs can be aggregated for all communication events of a stationary user. Such aggregation can, for example, be according to a time period (e.g., daily, weekly, monthly, and like). As provided below, such scores can be used to assign a probability of a user(s) visiting a particular POI. According to some embodiments, network/telecommunications (or service or content) providers can provide third parties with the complete POI information (e.g., the aggregated POI visit estimates and corresponding POI probabilities). For example, a third party can leverage POI estimates combined with other data to have forward looking projections of site visitations in order to prepare and/or allocate physical and computer hardware resources accordingly.

Accordingly, as discussed herein, the disclosed embodiments are configured to operate on and/or over a communication network to track location data for user devices, and determine the POIs that could and/or may have been impacted by visits by one or more user and/or their device. The disclosed embodiments can compile tracked location data, as well as, in some embodiments, historical data related to the user and/or the POIs, to determine predicted POIs the user has visited, which in some embodiments, can be aggregated for multiple users. In some embodiments, such predicted POIs and/or aggregation can be leveraged to estimate the user's/users' current location, where for an individual communication event, they can be estimated respective to a defined uncertainty sector (e.g., a geofenced, physical area of location in the real-world) and for multiple events, an uncertainty polygon (e.g., which operates similar to the uncertainty sector discussed herein, but as an aggregate of such sectors). Accordingly, as discussed herein, such estimation can be further utilized as a basis for improving the accuracy of the user location, as well as providing curated resource content that can correlate to the user's POI visits.

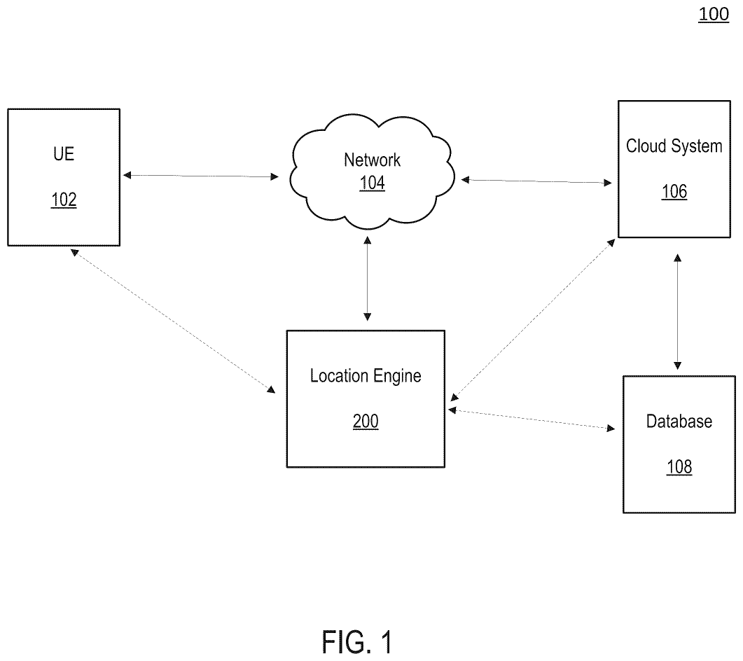

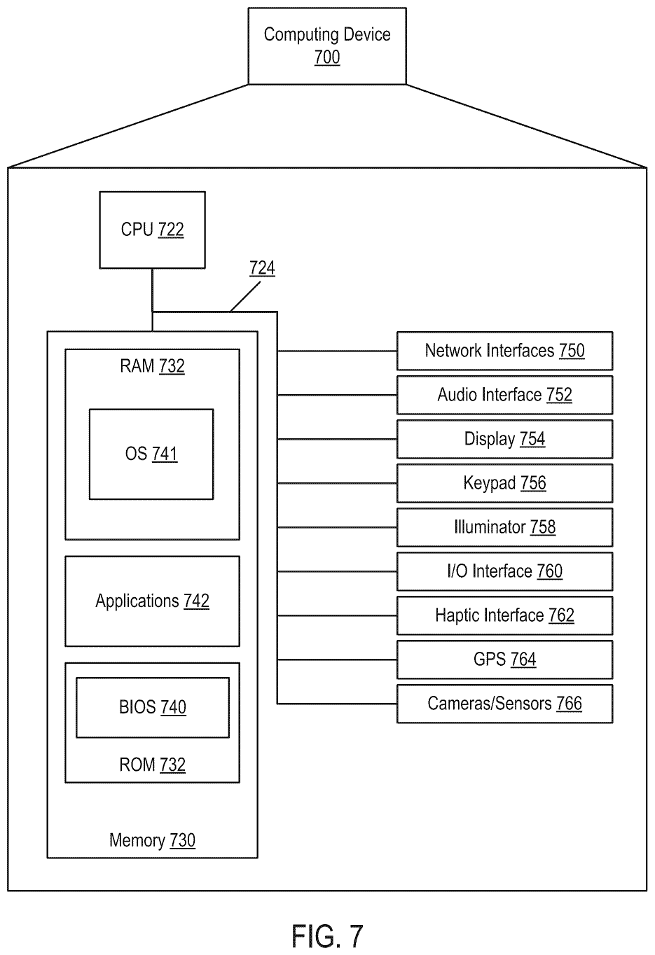

With reference to FIG. 1, system 100 is depicted which includes user equipment (UE) 102 (e.g., a client device, as mentioned above and discussed below in relation to FIG. 7), network 104, cloud system 106, database 108, and location engine 200. It should be understood that while system 100 is depicted as including such components, it should not be construed as limiting, as one of ordinary skill in the art would readily understand that varying numbers of UEs, engines, cloud systems, databases and networks can be utilized; however, for purposes of explanation, system 100 is discussed in relation to the example depiction in FIG. 1.

According to some embodiments, UE 102 can be any type of user device. For example, UE 102 can include, but not be limited to, a mobile phone, tablet, laptop, game console, smart television (TV), Internet of Things (IoT) device, wearable device, an autonomous vehicle (AV), autonomous machine, unmanned aerial vehicle (UAV), and/or any other device equipped with a cellular or wireless or wired transceiver.

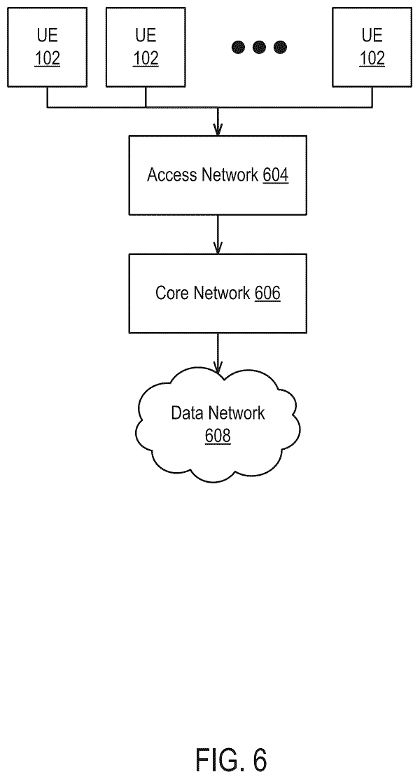

In some embodiments, network 104 can be any type of network, such as, but not limited to, a wireless network, cellular network, the Internet, and the like (as discussed above). Network 104 facilitates connectivity of the components of system 100, as illustrated in FIG. 1. Further discussion of embodiments of network 104 are provided below with reference to FIG. 6.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed. For example, system 106 can represent the cloud-based architecture associated with a cellular provider, which has associated network resources hosted on the internet or private network (e.g., network 104), which enables (via engine 200) the location-determinant operations discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102 and the services and applications provided by cloud system 106 and/or engine 200).

In some embodiments, for example, cloud system 106 can provide a private/proprietary management platform, whereby location engine 200, discussed infra, corresponds to the novel functionality system 106 enables, hosts and provides to a network 104 and other devices/platforms operating thereon.

According to some embodiments, database 108 may correspond to a data storage for a platform (e.g., a network hosted platform, such as cloud system 106, as discussed supra) or a plurality of platforms. Database 108 may receive storage instructions/requests from, for example, location engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Location engine 200, as discussed above and further below can include components for the disclosed functionality. According to some embodiments, location engine 200 may be a special purpose machine or processor, and can be hosted by a device on network 104, within cloud system 106 and/or on UE 102. In some embodiments, location engine 200 may be hosted by a server and/or set of servers associated with cloud system 106.

According to some embodiments, as discussed in more detail below, location engine 200 may be configured to implement and/or control a plurality of services and/or microservices, where each of the plurality of services/microservices are configured to execute a plurality of workflows associated with performing the disclosed connection management. Non-limiting embodiments of such workflows are provided below.

According to some embodiments, as discussed above, location engine 200 may function as an application provided by and/or hosted by cloud system 106. In some embodiments, location engine 200 may function as an application installed on a server(s), network location and/or other type of network resource associated with system 106. In some embodiments, location engine 200 may function as an application installed and/or executing on UE 102. In some embodiments, such application may be a web-based application accessed by UE 102. In some embodiments, location engine 200 may be configured and/or installed as an augmenting script, program or application (e.g., a plug-in or extension) to another application or program provided by cloud system 106 and/or executing on UE 102.

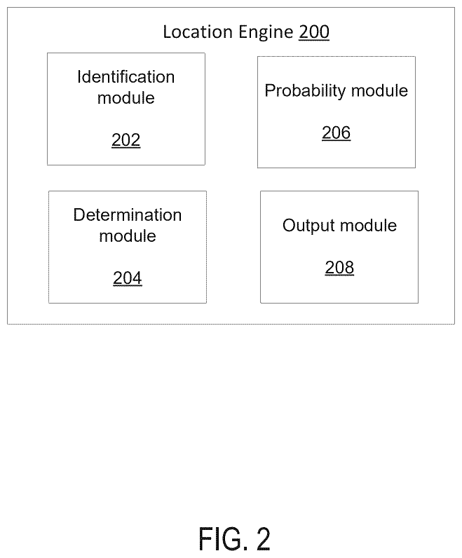

As illustrated in FIG. 2, according to some embodiments, location engine 200 includes identification module 202, determination module 204, probability module 206 and output module 208. It should be understood that the connection broker(s) and modules discussed herein are non-exhaustive, as additional or fewer brokers and/or modules (or sub-modules) may be applicable to the embodiments of the systems and methods discussed. More detail of the operations, configurations and functionalities of location engine 200 and each of its modules, and their role within embodiments of the present disclosure will be discussed below.

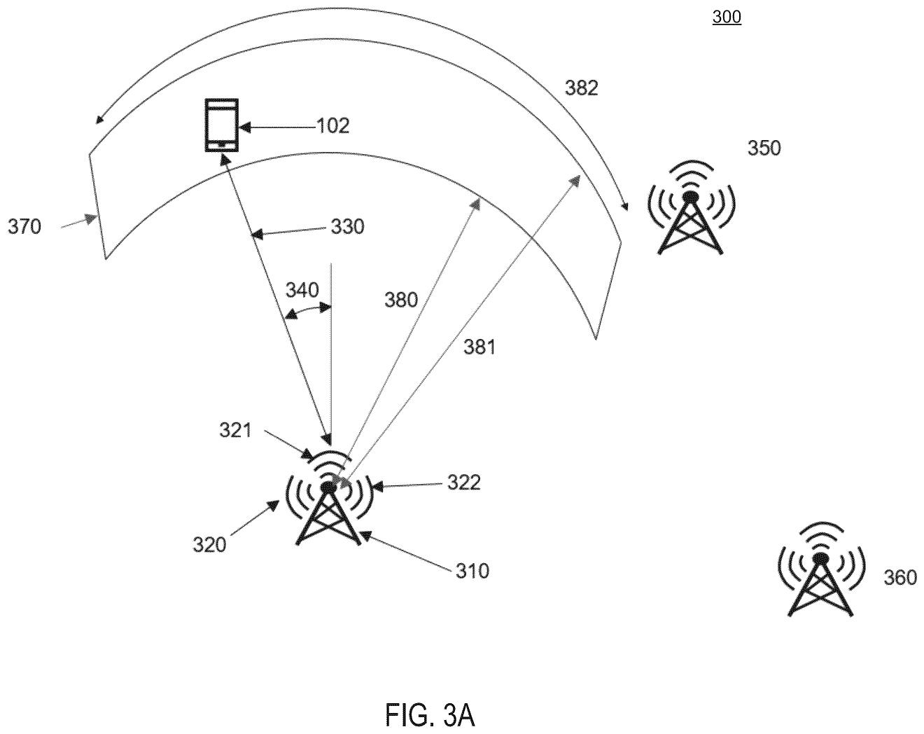

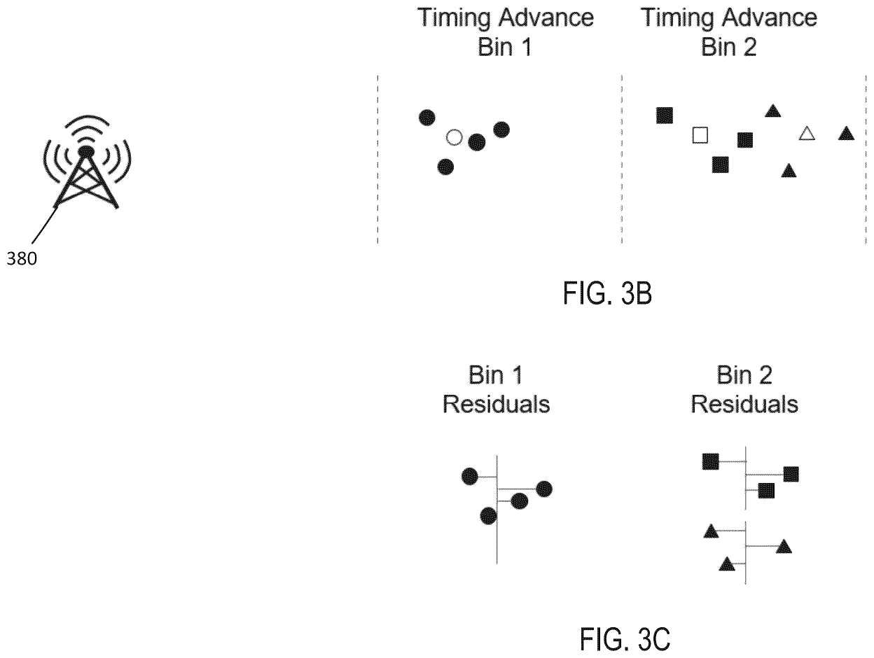

In FIG. 3A, example system 300 provides a non-limiting example embodiment for the optimization of parameters associated with the signals related to communication between a UE (e.g., mobile device of a user) and a cell tower (e.g., eNodeB).

According to some embodiments, as discussed herein, the disclosed framework can operate based at least on a sequence of communication events, which can be configured as a timestamped list of communication parameters whenever a UE makes a connection with a cell tower (e.g., eNodeB). In some embodiments, such communication events can originate from active and/or passive use of the UE. In some embodiments, the communication parameters can include, but are not limited to, an identifier of the UE (e.g., International Mobile Equipment Identity (IMEI) of a smartphone making the communication), and an identifier of the cell (e.g., antenna) the cell tower (e.g., the eNodeB) with which the device communicates, and the like.

According to some embodiments, other parameters relevant to location information can be included in the communication parameters for the event, which can include, but are not limited to, signal strength, timing advance (TA—which is an approximate of the amount of time it takes for a radio signal of a UE to reach the antenna of the cell tower), and the like. In some embodiments, auxiliary parameters can also be included, which can include, but are not limited to, the geolocation of the eNodeB, the azimuthal angle of the antenna, and the like. In some embodiments, the communication information can additionally include third party/vendor estimates and/or labels of a geolocation of the UE, and/or an indication of a sub-location (e.g., indoors or outdoors), and the like.

As discussed herein, the disclosed framework can operate, based on such communication information, to generate and output an aggregated estimate of visit counts and duration for selected POIs. As mentioned above, such aggregation can be performed continuously and/or according to a predetermined period of time (e.g., occur over a day, a week or any time period of interest for a consuming system, device or party).

According to some embodiments, with reference to example system 300 in FIG. 3A, a location uncertainty algorithm can be defined and executed via the disclosed framework. Knowledge of the location uncertainty can identify, from one or more POIs, where the user may be located. In some embodiments, the location uncertainty can have a complex, dynamically determined shape because estimating the distance from a cell tower antenna can be more accurate than estimating the angle with respect to the tower, and the UE may communicate with multiple towers.

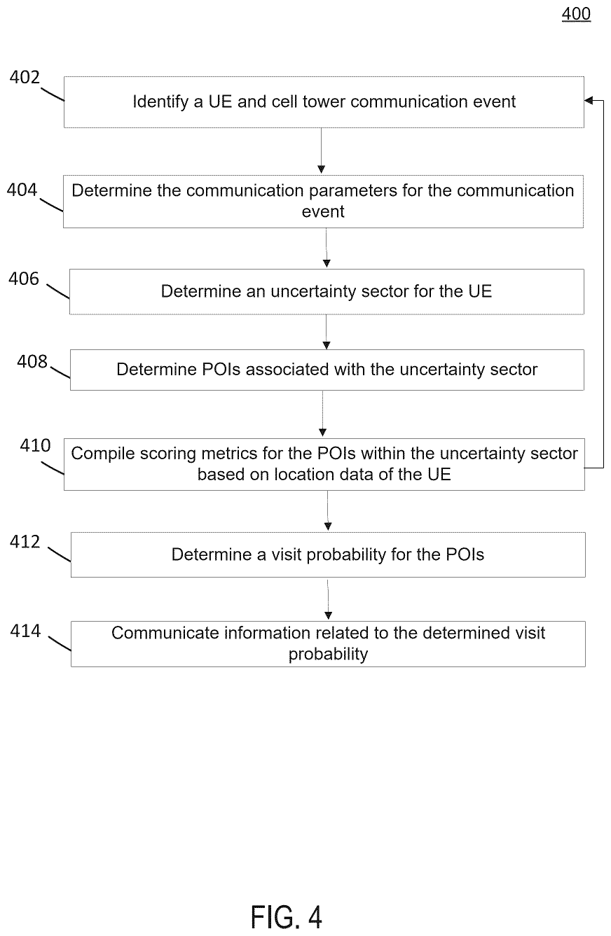

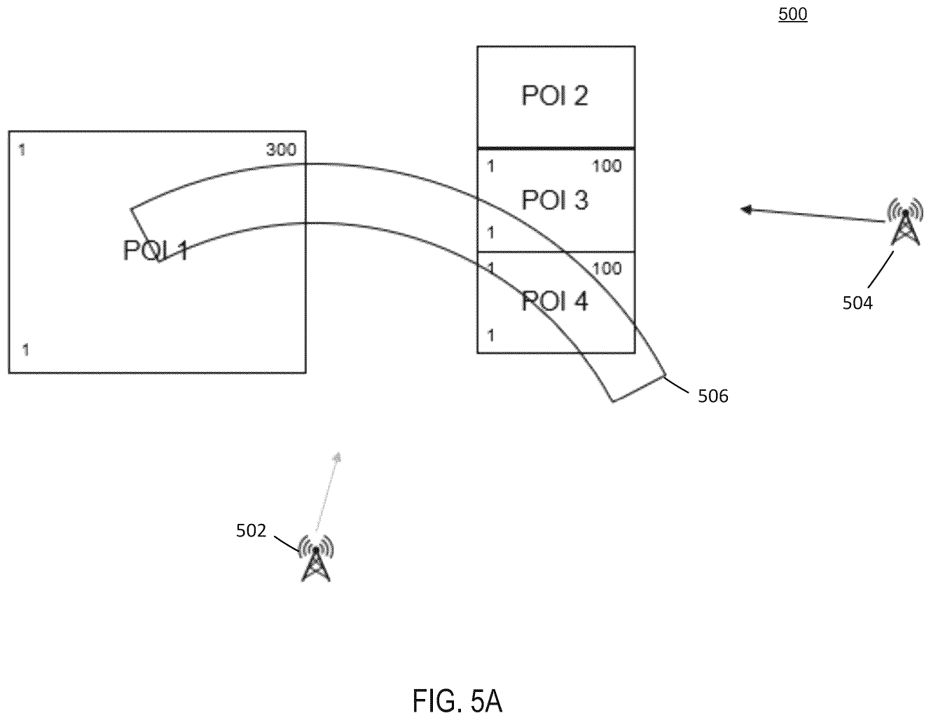

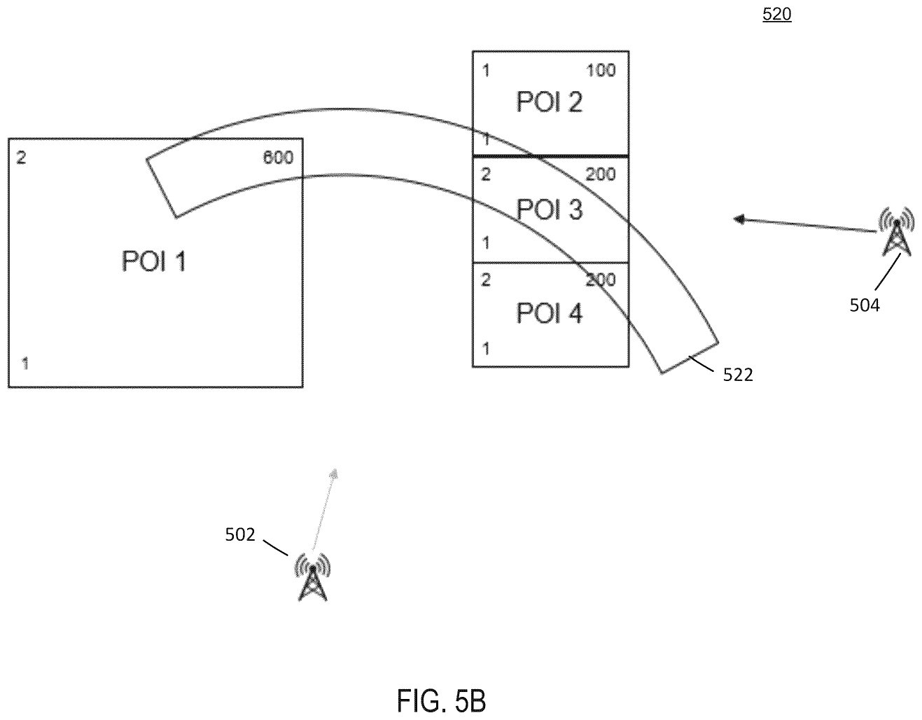

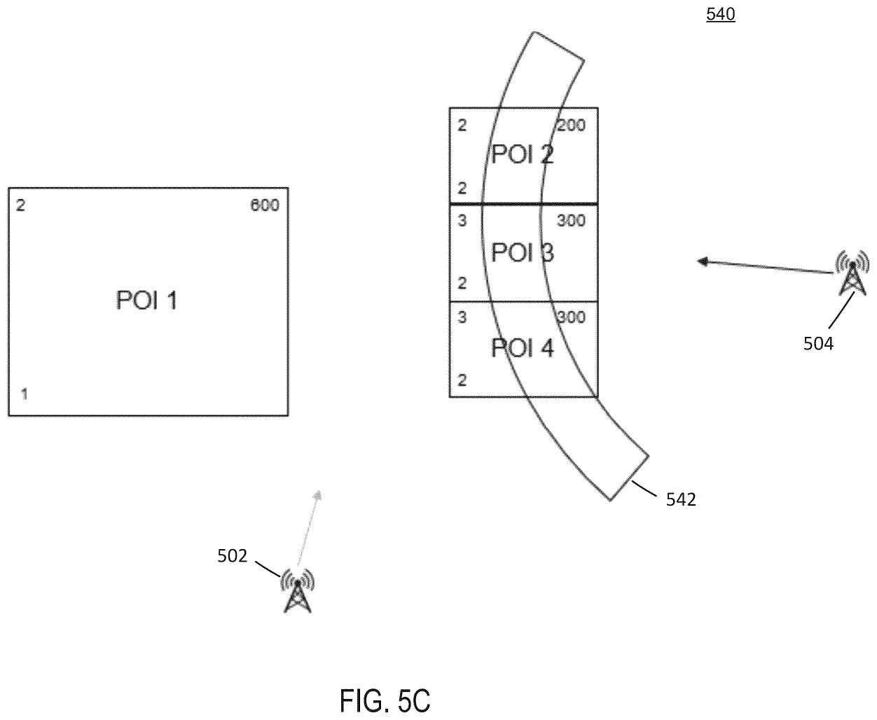

As discussed herein, with more details provided respective to FIGS. 4-5C, infra, the disclosed framework can determine or otherwise identify a non-circular area where a UE can be assigned with high precision. As discussed below, in some embodiments, the framework, via the location uncertainty algorithm, can eliminate POIs from consideration as a user's location, leading to more accurate visit estimates. Conventionally, current systems and mechanisms have had difficulty constructing a location uncertainty closed curve, as well as ascertaining a user's location therefrom; as such, the disclosed framework addresses such technical shortcomings and supplants the need to explicitly construct this closed curve, while enabling improved efficiency and accuracy in locating a user's location.

FIG. 3A illustrates an example of a communication of a UE 102 with an eNodeB 310. In non-limiting example system 300, eNodeB 310 has three cell antennas 320, 321, and 322. When a communication with cell antenna 321 occurs, for example, a TA 330 can be measured, which can be used to estimate the distance of the UE 102 from antenna 321. The azimuthal angle 340 with respect to the antenna's azimuth can be estimated from relative power levels of communication with neighboring cell antennas 350 and 360. According to some embodiments, the TA 330 can be determined more accurately than the azimuthal angle 340. Therefore, the user's uncertainty in position is given by uncertainty sector 370. Thus, the user (and UE 102) has a high probability of being within the uncertainty sector 370 and a lower probability of being outside sector 370.

According to some embodiments, the uncertainty sector 370 can be defined by a minimum radius 380, a maximum radius 381, and an angular extent 382. The minimum radius 380 and maximum radius 381 can be determined from multiple communication events from multiple devices (e.g., UEs) for stationary users. As discussed herein, the difference between the minimum radius 380 and the maximum radius 381 is dependent on the distance of the UE 102 from the cell tower 310.

According to some embodiments, minimum radius 380 and maximum radius 381 can be determined based on an error and/or confidence analysis performed respectively to the collected TA data for the positional relationship between the UE and the antennas of the cell tower (eNodeB). According to some embodiments, the TA(s) for the UE can be analyzed via any type of known or to be known algorithm, which can perform computational error and/or confidence basis algorithmic analysis on positional data (between two real-world entities), and as a result determine a set of measurements related to positional (or distance) values between the entities. The set of measurements can have a lower bound and an upper bound (according to threshold values), whereby the lower bound can be determined to correlate to the minimum radius 380 and the upper bound can correlate to the maximum radius 381.

In some embodiments, a TA can have a spatial resolution of 78 meters for 4G LTE, for example. Thus, for example, a minimum radius can be computed by taking 78 meters from the TA, and the maximum radius can be computed by adding 78 meters to the TA.

By way of a non-limiting example, according to some embodiments, FIG. 3B depicts an example of TA measurements for 3 stationary users. For example, User 1 has 4 communication events, illustrated by the solid circles. User 2 has 3 communication events, illustrated by the solid squares. User 3 also has 3 communication events, illustrated by the solid triangles.

According to some embodiments, as discussed herein, if user 1 is not moving, the TA may be expected to remain the same while the user is stationary. However, in some embodiments, because of variations in the nature of communication between the user equipment and the cell antenna (e.g., 380, in FIGS. 3B-3C), the TA can differ. Accordingly, in some embodiments, the average of such TAs can be computed to represent a true distance of the user (e.g., User 1) from the tower 380. Such averaging computations are discussed in more detail below.

Accordingly, as depicted in FIG. 3A, an average TA for users 1, 2 and 3, respectively, are illustrated by the open circle, square and triangle, respectively.

In some embodiments, a difference between an instantaneous measurement of the TA and the average TA can result in a TA residual. Accordingly, as discussed herein, the residual TA can be calculated for each communication event for each tower, as depicted in FIG. 3C. In some embodiments, TA residuals can depend on a magnitude of the TA; in other words, the TA advance noise is heteroskedastic.

As depicted in FIG. 3C, TAs can be partitioned into bins, whereby their corresponding TA residuals can be computed based on the difference between the TA measurement (solid symbols) and the average TA (open symbols). For each TA bin, a metric of the noise can be calculated. Once such example metrics is a 90% confidence interval. For example, the lower bound of a 90% confidence interval is a value for a residual for which 5% of the residuals would be smaller than the lower bound and 95% of the residuals would be greater than the lower bound. The upper bound of a 90% confidence interval is a value for the residual for which 5% of the residuals would be larger than the upper bound and 95% of the residuals would be less than the upper bound. The relative lower bound can be defined as the difference between the TA bin midpoint and the lower bound. The relative upper bound can be defined as the difference between the upper bound and the TA bin midpoint. After this determination of residuals for all TA bins and all cells, for any TA measurement, the minimum radius for the uncertainty sector would be set to the TA minus the relative lower bound and the maximum radius for the uncertainty sector would be set to the TA plus the relative upper bound. In some embodiments, the bins can have a bin interval equal to a predetermined quantization. In some embodiments, if the quantization is too small (e.g., below a threshold), there may not be a large enough sample of stationary users to capture the noise level. On the contrary, if the quantization is too large (at or above a threshold), the distance dependence of the noise may not be capturable with enough precision (e.g., to a threshold precision value). Thus, as in FIGS. 3B-3C, the bin quantization is depicted by the vertical dotted lines. The TAs and their residuals from user 1 lie in bin 1, and the TAs and their TA residuals from user 2 and user 3 lie in bin 2.

In some embodiments, the angular extent 382 of the uncertainty sector 370 can be taken to be a communication parameter, however it would typically be based on the angular extent of the cell antenna (e.g. 120 degrees from antenna 321). Usually a cell tower can contain multiple antennas, sometimes with overlapping angular extents they are able to provide service to. The communication event, however, is serviced by only one of those antennas; therefore, the angular extent 382 of the communication event would still match with that of the antenna that is providing the service. In some embodiments, power readings from neighboring cells may also provide additional information to further limit where the user is within the servicing antenna's angular extent.

Turning to FIG. 4, Process 400 is disclosed which provides non-limiting example embodiments for setting a UE location based on determined probabilities that the UE is proximately located to particular POIs in a geographic area.

According to some embodiments, Step 402 of Process 400 can be performed by identification module 202 of location engine 200; Steps 404-408 can be performed by determination module 204; Steps 410 and 412 can be performed by probability module 206; and Step 414 can be performed by output module 208.

According to some embodiments, Process 400 begins with Step 402 where a communication event between a UE and a cell tower is identified. As discussed above, such communication event can be an active or passive communication event.

According to some embodiments, Step 402 can involve engine 200 determining stationary users communicating with a cell tower. By way of example, a user device is determined as being stationary, and in such embodiment, is determined to have actively and/or passively connected to a cell tower. According to some embodiments, the communication event (which, in some embodiments, can correspond to a set of communications to, from and/or between the UE and the cell tower) can be detected and corresponding communication data collected for a time period (e.g., a stationary time period; that is, a period of time the UE is determined to be stationary).

According to some embodiments, Step 402 can involve identifying a communication event when the user is determined to be stationary, as discussed above. Thus, Step 402 and the subsequent steps of Process 400 can correspond to the detection that the user is stationary and communications event associated with such stationary status is detected/identified.

In Step 404, engine 200 can determine the communication parameters for the communication event. The communication parameters provide information related to an estimated position of the UE to the cell tower when the UE is determined to be stationary, as discussed above. According to some embodiments, Step 404 can involve performing a computational analysis of the distance data and communication data between the UE and cell tower in a similar manner as discussed above at least in relation to FIGS. 3A-3C.

By way of example, with reference to FIG. 5A, the TA between a UE and an antenna of cell tower 502 can correspond to a distance between the two entities. As discussed herein, the location of the UE is not known at the onset of processing, and its positioning is only estimated/predicted to be within the uncertainty sector 506. According to some embodiments, if/when the UE (e.g., user) is not moving (e.g., stationary) and communicating an event (as discussed above respective to Step 402), the TA can be anticipated to remain the same while the user is stationary; however, due to variations in the nature of communication between a UE and an antenna of a cell tower, the TA can also vary.

In Step 406, based on the determined communication parameters (from Step 404), engine 200 can determine an uncertainty sector for the UE. As a non-limiting example, as in FIG. 5A, the determined uncertainty sector for the UE is depicted as uncertainty sector 506. According to some embodiments, uncertainty sector 506 can be defined by a minimum radius, a maximum radius, and an angular extent, as discussed above at least in relation to FIG. 3A.

In Step 408, engine 200 can determine the POIs that are associated with the determined uncertainty sector. In some embodiments, POIs can be determined to be associated with the uncertainty sector if they at least overlap, at least partially, with the uncertainty sector. That is, for example, as provided below with reference to FIGS. 5A-5C, if at least a portion of the physical, geographic area occupied by the POI corresponds to at least a portion of the area covered by the uncertainty sector. If a POI falls outside the uncertainty sector, they are determined to not be associated.

For example, as depicted in FIG. 5A, POIs 1, 2, 3 and 4 are 4 POIs in a proximate area of cells 502 and 504. There may be other POIs, and for simplicity, they are not shown. As depicted, POI 1, POI 3 and POI 4 are associated with the determined uncertainty sector, and POI 2 is not because it falls outside the physical area covered by the uncertainty sector.

According to some embodiments, three conditions for a POI to overlap with the uncertainty sector may be required to be satisfied. That is, a POI overlaps the uncertainty sector when i) the closest point of the POI to the cell tower is within the outer arc; ii) the furthest point of the POI to the cell tower is outside the inner arc; and iii) the POI lies within the angular extent of the uncertainty sector.

To state in another way, for a particular POI, assume it is of a circular area of radius rₚ, let rᵢ be the inner radius (e.g., minimum radius) of the uncertainty sector and rₒ be the outer radius (e.g., maximum radius) of the uncertainty sector which are determined through an algorithm. Also, let d be the distance between the center of the POI and the cell antenna location. The point of closest extent of the POI must be less than the outer radius of the uncertainty sector, and the point of furthest extent of the POI must be greater than the inner radius of the uncertainty sector. Mathematically, this is expressed as:

$$d - {r}_{p} < {r}_{o} and d + {r}_{p} > {r}_{1} , \qquad Eq . 1.$$

Moreover, POI location must also be within the angular extent of the uncertainty sector (discussed above), which can also be expressed mathematically. For example, let θₚ be the azimuthal angle of the vector pointing from the antenna of the cell tower to the POI, θ_{c} be the azimuthal direction that the cell antenna is pointed, and θₐ be the angular extent of the uncertainty sector. Mathematically this is expressed as;

$$abs ( mod ( {θ}_{p} - {θ}_{c} + π , 2 π ) - π ) ) < {θ}_{a} / 2 , \qquad Eq . 2.$$

Accordingly, as discussed herein, only a set of conditions that a POI must meet to be located within the uncertainty sector for a communication event are needed. This improves not only the accuracy of determining the uncertainty sector and the POIs positioning therein for the communication event, but also the efficiency in which the sector can be defined for which the POI can be analyzed.

In Step 410, engine 200 can compile scoring metrics for the POIs within the uncertainty sector. The scoring metrics are incremented for each communication event. Thus, a set of scoring metrics (also referred to as component scores, used interchangeably) can be compiled for a set of communication events. Such recursive (or repeated) compilation for POIs is depicted in FIG. 4 via the line that reverts the processing from Step 410 to Step 402. This enables communication events to be properly analyzed within the same stationary time period in order to produce the user's most-likely POIs visited by tallying up the POIs of intersection within each communication event.

By way of a non-limiting example, FIG. 5A corresponds to a first communication event, FIG. 5B corresponds to a second communication event, and FIG. 5C corresponds to a third communication event. Such communication events can be processed in a similar manner as discussed above respective to Steps 402-410.

As depicted in FIG. 5A-5C, a first component score is the integer in the upper left corner of each POI corresponds to a number of times that the respective POI is determined to be within an uncertainty sector; a second component score is the integer in the bottom left corner corresponds to a number of unique eNodeBs the POI can communication with; and a third component score is the integer/number in the upper right corner is the sum of the area of the POI for each communication event.

For example, in example 500 of FIG. 5A, the uncertainty sector 506 overlaps POI 1, POI 3 and POI 4. These POIs can be scored to indicate a metric tally that such POIs are within the uncertainty sector. As above, the first component score is to increment the score by one for each communication event a POI overlaps with the uncertainty sector. Thus, the integer in the upper left corner can be incremented for each communication event.

The second component score is to increment the value in the bottom left corner to indicate how many eNodeBs placed a respective POI in the uncertainty sector (e.g., how many eNodeBs did the POI communication with for the communication event). In some embodiments, such score can be weighted based on the direction of eNodeB. For example, communication with a short range omnidirectional eNodeB can be weighted more than a unidirectional eNodeB.

And, the third component score is a product of the area of the POI and the number of times it was included in the uncertainty sector (e.g., the second component score). Therefore, for POI 1, for example in FIG. 5A, the “300” indicates that the square footage of the POI is 300 square feet multiplied by 1 count of being within the uncertainty sector 506. This third component score captures the fact that a larger area POI is more likely to contain a user compared to a smaller area POI.

According to some embodiments, component scores can further involve, but are not limited to, an amount or percentage of the POI overlap with the uncertainty sector, a percentage of POIs in an area overlapping the uncertainty sector, opening and closing hours of a POI, the distance of the POI from an estimate of the most likely UE location, and the like. Accordingly, component scores can be contemplated for any type of known attribute related to a user visit to a POI, which can be based on and/or correspond to a time, date, activity, event, and the like, or some combination thereof.

Continuing with the example, upon another communication event, in example 520 of FIG. 5B, the UE is determined to be proximate to POI 1, POI 2, POI 3 and POI 4 (based on such POIs being within uncertainty sector 522). A new uncertainty sector 522 is determined for the subsequent communication event, as discussed above. Thus, the component scores for these POIs can be updated as reflected in FIG. 5B.

Then, upon a third communication event, in example 540 of FIG. 5C, the UE is determined to be proximate to POI 2, POI 3 and POI 4 (based on such POIs being within uncertainty sector 542 (where, as above, a new uncertainty sector 542 is determined for the third communication event). Thus, the component scores for these POIs can be updated, as reflected in FIG. 5C.

According to some embodiments, Step 410 compilation of scoring metrics for the POIs can be subject to a weighting value determined and applied by engine 200. For example, there may be situations where a UE communicates with an antenna of a cell tower many times, while only communicating with another co-located antenna of another cell tower once. For example, in FIGS. 5A-5C, for examples 500 and 520, the UE is communicating with cell tower 502; however, in example 540, UE 501 is communicating with cell tower 504. This may lead to uneven scoring, as tower 504 is closer to POIs 2-4 than tower 502, which can lead to dissimilar uncertainty sector projections. Thus, a weighting score can be determined in relation to the connected cell tower, whereby a score for a POI may be divided by a number of communication events with the same cell tower.

An example of such scoring, which may be subject to a weighting determination, is depicted in the below table, where, “unique eNodeB” corresponds to the number of distinct eNodeBs that are within range of the POI. For example, for POIs 2-4, from FIGS. 5A-5C, towers 502 and 504 are within range, while for POI 1, only tower 502 is within range.

TABLE 1

| | | | Communication | Component |
|---|---|---|---|---|
| POI | Area (m²) | Unique eNodeB | Event count | Score |
| 1 | 300 | 1 | 2 | 600 |
| 2 | 100 | 2 | 2 | 4200 |
| 3 | 100 | 2 | 3 | 300 |
| 4 | 100 | 2 | 3 | 300 |

Accordingly, from the above Table 1, the score for POI 4 is the largest, which can indicate that UE 501 (and the corresponding user) are most likely at POI 4.

In Step 414, engine 200 can determine a visit probability for the POIs. In some embodiments, such probability can be based on the above scoring, whereby the POI with the highest determined score can be utilized to set the UE location, as in Step 414. In some embodiments, engine 200 can execute any type of algorithm, as discussed above, that are capable of normalizing a score based on a number of determined visits (e.g., tally value) to produce a probability for the geographic positioning of the UE. In some embodiments, such probabilistic determination can involve dividing the POI score for each POI by a sum of all POI scores, whereby the POI with the highest value subject to the divisional operation can be identified as the most likely location of the user/UE.

Thus, in Step 414, engine 200 can communicate the information related to the determined visit probability to a third party. As discussed above, and in non-limiting examples below, such communication can be compiled as an electronic message that can be electronically shared over a network to advise to the probability that a user is within an area (e.g., either currently and/or in the past).

In some embodiments, Step 414 can involve setting the UE location based on the determined probabilities from Step 412. The information in the communication can correspond to such UE location. In some embodiments, the setting of the location can correspond to a determine physical range or geographic area of the UE, as predicted via the visit probability for the POIs.

In some embodiments, the communication of the probabilities and/or setting of the UE location involves a series of integrated actions and systems that update the cellular network's understanding and record of the UE's position. This process not only enhances the accuracy of the UE's location within the network but also enables a variety of downstream applications and services that rely on precise location data. Upon generating the predicted geocoordinate, the cellular network's databases can be updated with this new information. This update ensures that the network's internal systems, such as those involved in managing calls, messages and data sessions, have the most current and accurate location information for the UE. The update process typically involves communication between the UE and the network's core systems, facilitated through base stations or cell towers (also referred to as network stations, used interchangeably). This ensures that the location information is consistently synchronized across the network's architecture.

According to some embodiments, accurately locating an aggregate of UE within POIs improves the quality and reliability of location-based services offered by the network. These services range from basic functionalities like routing calls and messages to more complex applications like emergency services response (e.g., Enhanced 911 (E911) in the United States). Beyond traditional network services, the updated location information enables context-aware services. These services adjust their functionality based on the UE's location, providing personalized content, location-specific recommendations, and enhanced user experiences.

According to some embodiments, the following provides some non-limiting examples of location-based services that may be provided using an accurate stationary position of a UE.

In some embodiments, as discussed above, the cellular network can generate location-based analytics. Such networks can aggregate and analyze stationary UE location data to provide clients with volumes of POI visits based solely on cellular network data. Thus, such a technique does not rely on tracking applications or other third-party tools and can leverage POI tracking using only cellular communications parameters.

As another example, in the event of natural disasters like earthquakes or floods, accurately setting UE locations (especially for stationary UEs) can be used for rescue and relief operations. Emergency services can quickly locate and prioritize areas where people are stranded or in need of assistance. Similarly, law enforcement agencies can use this data to enhance public safety measures, monitor high-risk areas, and respond more effectively to incidents.

As another example, during health crises like pandemics, precise location data can help track the spread of diseases. This information is vital for implementing targeted containment measures and resource allocation. For mobile healthcare services, especially in rural or underserved areas, accurate UE location setting can optimize routes and ensure timely delivery of medical services.

The foregoing are merely some examples of uses of more accurate location data (as compared to GSM location estimates) obtained using the processes described herein. As discussed previously, the applications are achievable solely through communications parameters intrinsic to the cellular network and require no action from the UEs analyzed, thus allowing for widespread adoption of the technique across a cellular network.

FIG. 6 is a block diagram of an example network architecture according to some embodiments of the present disclosure. In the illustrated embodiment, UE 102 accesses a data network 608 via an access network 604 and a core network 606.

In the illustrated embodiment, the access network 604 comprises a network allowing network communication with UE 102. In general, the access network 604 includes at least one base station that is communicatively coupled to the core network 606 and coupled to zero or more UE 102.

In some embodiments, the access network 604 a cellular access network, for example, a 5G network. In an embodiment, the access network 604 can include a NextGen Radio Access Network (NG-RAN). In an embodiment, the access network 604 includes a plurality of next Generation Node B (e.g., eNodeB and gNodeB) base stations (or network station) connected to UE 102 via an air interface. In one embodiment, the air interface comprises a New Radio (NR) air interface. For example, in a 5G network, individual user devices can be communicatively coupled via an X2 interface.

In the illustrated embodiment, the access network 604 provides access to a core network 606 to UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 606 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 606 and to external network-attached elements in a data network 608 such as the Internet.

In the illustrated embodiment, the access network 604 and the core network 606 are operated by a NO. However, in some embodiments, the networks (604, 606) may be operated by a private entity and may be closed to public traffic. For example, the components of the network 606 may be provided as a single device, and the access network 604 may comprise a small form-factor base station. In these embodiments, the operator of the device can simulate a cellular network, and UE 102 can connect to this network similar to connecting to a national or regional network.

In some embodiments, the access network 604, core network 606 and data network 608 can be configured as a MEC network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

FIG. 7 is a block diagram illustrating a computing device showing an example of a client or server device used in the various embodiments of the disclosure.

The computing device 700 may include more or fewer components than those shown in FIG. 7, depending on the deployment or usage of the device 700. For example, a server computing device, such as a rack-mounted server, may not include audio interfaces 752, displays 754, keypads 756, illuminators 758, haptic interfaces 762, GPS receivers 764, or cameras/sensors 766. Some devices may include additional components not shown, such as graphics processing unit (GPU) devices, cryptographic co-processors, artificial intelligence (AI) accelerators, or other peripheral devices.

As shown in FIG. 7, the device 700 includes a CPU 722 in communication with a mass memory 730 via a bus 724. The computing device 700 also includes one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal, or electromagnetic sensors 766. Device 700 can include one camera/sensor 766 or a plurality of cameras/sensors 766. The positioning of the camera(s)/sensor(s) 766 on the device 700 can change per device 700 model, per device 700 capabilities, and the like, or some combination thereof.

In some embodiments, the CPU 722 may comprise a general-purpose CPU. The CPU 722 may comprise a single-core or multiple-core CPU. The CPU 722 may comprise a system-on-a-chip (SoC) or a similar embedded system. In some embodiments, a GPU may be used in place of, or in combination with, a CPU 722. Mass memory 730 may comprise a dynamic random-access memory (DRAM) device, a static random-access memory device (SRAM), or a Flash (e.g., NAND Flash) memory device. In some embodiments, mass memory 730 may comprise a combination of such memory types. In one embodiment, the bus 724 may comprise a Peripheral Component Interconnect Express (PCIe) bus. In some embodiments, the bus 724 may comprise multiple busses instead of a single bus.

Mass memory 730 illustrates another example of computer storage media for the storage of information such as computer-readable instructions, data structures, program modules, or other data. Mass memory 730 stores a basic input/output system (“BIOS”) 740 for controlling the low-level operation of the computing device 700. The mass memory also stores an operating system 741 for controlling the operation of the computing device 700.

Applications 742 may include computer-executable instructions which, when executed by the computing device 700, perform any of the methods (or portions of the methods) described previously in the description of the preceding Figures. In some embodiments, the software or programs implementing the method embodiments can be read from a hard disk drive (not illustrated) and temporarily stored in RAM 732 by CPU 722. CPU 722 may then read the software or data from RAM 732, process them, and store them to RAM 732 again.

The computing device 700 may optionally communicate with a base station (not shown) or directly with another computing device. Network interface 750 is sometimes known as a transceiver, transceiving device, or network interface card (NIC).

The audio interface 752 produces and receives audio signals such as the sound of a human voice. For example, the audio interface 752 may be coupled to a speaker and microphone (not shown) to enable telecommunication with others or generate an audio acknowledgment for some action. Display 754 may be a liquid crystal display (LCD), gas plasma, light-emitting diode (LED), or any other type of display used with a computing device. Display 754 may also include a touch-sensitive screen arranged to receive input from an object such as a stylus or a digit from a human hand.

Keypad 756 may comprise any input device arranged to receive input from a user. Illuminator 758 may provide a status indication or provide light.

The computing device 700 also comprises an input/output interface 760 for communicating with external devices, using communication technologies, such as USB, infrared, Bluetooth™, or the like. The haptic interface 762 provides tactile feedback to a user of the client device.

The optional GPS transceiver 764 can determine the physical coordinates of the computing device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS, or the like, to further determine the physical location of the computing device 700 on the surface of the Earth. In one embodiment, however, the computing device 700 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
detecting a communication event between a device and a network station;
determining communication parameters for the communication events, the communication parameters comprising information related to signals communicated between the device and the network station and positional information between the device and the network station;
determining, based on the communication parameters, an uncertainty sector for the device, the uncertainty sector corresponding to a geographic area as defined by the communication parameters;
determining a set of points of interest (POI) that overlap the uncertainty sector, the overlap determination corresponding to at least a portion of a geographic area of a POI overlapping the geographic area of the uncertainty sector;
determining, for each POI in the set of POIs, a visit probability for the device; and
communicating, over a network, information related to the determined visit probability, the communication enabling tracking of the device for a time period.

2. The method of claim 1, further comprising:
setting a proximate location for the device based on the determined visit probability, wherein the communication comprises information related to the proximate location.

3. The method of claim 1, further comprising:
detecting a sequential set of communication events;
determining an uncertainty sector for each communication event in the sequential set;
determining, for each uncertainty sector, a plurality of component scores; and
determining, based on an aggregate of the determined score for each uncertainty sector, a visit probability of the device for each POI in the set of POIs.

4. The method of claim 3, wherein the sequential set of communication events occur during a time period where the device is stationary.

5. The method of claim 1, wherein the communication parameters comprise information related to an identifier of the device, identifier of the network station, timing advance (TA) between the device and the network station, signal strength of the communication event, geolocation of the network station, an angular extent of antennas of the network station, and azimuthal angle of an antenna of the network station.

6. The method of claim 5, further comprising:
determining, based at least on the TA, a minimum radius and maximum radius that correspond to a determined distance range for which the device is located from the network station; and
determining, based on the minimum radius, maximum radius and the angular extent of the antennas of the network station, the uncertainty sector.

7. The method of claim 1, further comprising:
determining, for each of the set of POIs, a set of component scores, the component scores being metric values that are dependent on the communication parameters during the communication event.

8. The method of claim 7, wherein a component score in the set of component scores for a respective POI is incremented when at least one occurrence involves the respective POI overlapping at least a portion of the uncertainty sector.

9. The method of claim 7, wherein a component score in the set of component scores is based on at least one of an area of the POI and a number of times the respective POI has communicated with a unique eNodeB during the communication event.

10. The method of claim 9, further comprising:
determining, based on an identifier of the network station of the communication event, a weighting value; and
applying the weighting value to the component score related to the unique eNodeBs for each POI in the set of POIs.

11. The method of claim 1, wherein the communication event corresponds to a determination that the device is stationary.

12. A device comprising:
a processor configured to:
detect a communication event between a device and a network station;
determine communication parameters for the communication events, the communication parameters comprising information related to signals communicated between the device and the network station and positional information between the device and the network station;
determine, based on the communication parameters, an uncertainty sector for the device, the uncertainty sector corresponding to a geographic area as defined by the communication parameters;
determine a set of points of interest (POI) that overlap the uncertainty sector, the overlap determination corresponding to at least a portion of a geographic area of a POI overlapping the geographic area of the uncertainty sector;
determine, for each POI in the set of POIs, a visit probability for the device; and
communicate, over a network, information related to the determined visit probability, the communication enabling tracking of the device for a time period.

13. The device of claim 12, wherein the processor is further configured to:
determine, for each of the set of POIs, a set of component scores, the component scores being metric values that are dependent on the communication parameters during the communication event,
wherein a component score in the set of component scores for a respective POI is incremented when at least one occurrence involves the respective POI overlapping at least a portion of the uncertainty sector, and
wherein a component score in the set of component scores is based on at least one of an area of the POI and a number of times the respective POI has communicated with a unique eNodeB during the communication event.

14. The device of claim 13, wherein the processor is further configured to:
determine, based on an identifier of the network station of the communication event, a weighting value; and
apply the weighting value to the component score related to the unique eNodeBs for each POI in the set of POIs.

15. The device of claim 12, wherein the processor is further configured to:
detect a sequential set of communication events, wherein the sequential set of communication events occur during a time period where the device is stationary;
determine an uncertainty sector for each communication event in the sequential set;
determine, for each uncertainty sector, a plurality of component scores; and
determine, based on an aggregate of the determined score for each uncertainty sector, a visit probability of the device for each POI in the set of POIs.

16. The device of claim 12, wherein the communication parameters comprise information related to an identifier of the device, identifier of the network station, timing advance (TA) between the device and the network station, signal strength of the communication event, geolocation of the network station, an angular extent of antennas of the network station, and azimuthal angle of an antenna of the network station.

17. The device of claim 16, wherein the processor is further configured to:
determine, based at least on the TA, a minimum radius and maximum radius that correspond to a determined distance range for which the device is located from the network station; and
determine, based on the minimum radius, maximum radius and the angular extent of the antennas of the network station, the uncertainty sector.

18. A non-transitory computer-readable storage medium tangibly encoded with computer-executable instructions, that when executed by a device, perform a method comprising:
detecting a communication event between a device and a network station;
determining communication parameters for the communication events, the communication parameters comprising information related to signals communicated between the device and the network station and positional information between the device and the network station;
determining, based on the communication parameters, an uncertainty sector for the device, the uncertainty sector corresponding to a geographic area as defined by the communication parameters;
determining a set of points of interest (POI) that overlap the uncertainty sector, the overlap determination corresponding to at least a portion of a geographic area of a POI overlapping the geographic area of the uncertainty sector;
determining, for each POI in the set of POIs, a visit probability for the device; and
communicating, over a network, information related to the determined visit probability, the communication enabling tracking of the device for a time period.

19. The non-transitory computer-readable storage medium of claim 18, further comprising:
determining, for each of the set of POIs, a set of component scores, the component scores being metric values that are dependent on the communication parameters during the communication event,
wherein a component score in the set of component scores for a respective POI is incremented when at least one occurrence involves the respective POI overlapping the uncertainty sector, and
wherein a component score in the set of component scores is based on an area of the POI, and wherein a component score in the set of component scores corresponds to a number of times the respective POI has communicated with a unique eNodeB during the communication event.

20. The non-transitory computer-readable storage medium of claim 18, further comprising:
detecting a sequential set of communication events, wherein the sequential set of communication events occur during a time period where the device is stationary;
determining an uncertainty sector for each communication event in the sequential set;
determining, for each uncertainty sector, a plurality of component scores; and
determining, based on an aggregate of the determined score for each uncertainty sector, a visit probability of the device for each POI in the set of POIs.
